(19) United States
(12) Patent Application Publication
(10) Pub. No.: US 2016/0347506 A1
(43) Pub. Date: Dec. 1, 2016

(54) METHOD AND APPARATUS FOR PACKAGING LUBRICANT TUBES

(71) Applicants: Mark Sterling, North Kansas City, MO (US); Justin Jewkes, North Kansas City, MO (US)

(72) Inventors: Mark Sterling, North Kansas City, MO (US); Justin Jewkes, North Kansas City, MO (US)

(73) Assignee: Martin operating Partnership L.P., Kilgore, TX (US)

(21) Appl. No.: 14/723,329

(22) Filed: May 27, 2015

(51) Int. Cl. B65D 25/20; B65D 79/02; B65C 9/00; F16N 37/02; B65C 3/02

(52) U.S. Cl. CPC B65D 25/205; F16N 37/02; B65C 3/02; B65C 9/00; B65D 79/02

(57) ABSTRACT

A labeled lubricant tube and method for labeling said lubricant tube, wherein the lubricant tube includes a shrink sleeve with labeling information. The labeling information is printed on the inside of the shrink sleeve and is in direct contact with a surface of the lubricant tube. The shrink sleeve also reinforces the lubricant tube, secures a cap to the end of the lubricant tube, and provides tamper resistance/evidence.

### BACKGROUND OF THE DISCLOSURE

1. Field of the Disclosure

This disclosure relates to the field of lubricant packaging, especially labeling and tamper evidence for grease tubes.

2. Description of the Related Art

Grease is used as a lubricant because it clings to the surfaces of moving parts of a machine rather than leaking away like oil. Grease is denser and more viscous than lubricating oils. Typically, grease is applied to machinery using a grease gun, which provides pressure to force the grease out of a grease storage container, such as a grease tube.

Grease tubes or cartridges or packaging are typically cylindrical tubes (tubulars) made of plastic or fiber with labeling information printed on the surface of the tubular. These cylindrical tubes come in many sizes. The grease tube is configured to be received by the grease gun. Several grease gun manufacturers recommend applying some the grease from the opened tube to the surface of the tube to easy the passage of the grease tube into the grease gun during loading and removal. Typically, one end of the grease tube includes a removable portion, such as a pull top, and the other end includes a removable cap. When loaded into a grease gun with the pull top and cap removed, the grease can be forced through the tube by the grease gun and applied to the machinery.

Since grease tubes come in multiple sizes, each of which may apply to different machines, storage space for grease at an industrial facility is reduced when odd sizes are of grease tubes are stored together. This means that storage space is wasted due to a lack of a standardized size for grease tubes.

A shortcoming of current grease tubes is that the grease may efface the printing on the fiber or plastic surface of the grease tube. Grease tubes may also deteriorate or become effaced when exposed to water. Effacement may be due to water on the surface or damage to the tube surface underlying the print. Even grease used to lubricate the outside of the tube may damage the underlying print.

Another shortcoming of current grease tubes is that different types of grease may affect the print quality in different ways. Thus, multiple types of ink, printing, or tube materials may be needed to provide suitable print quality.

Another shortcoming of current grease tubes is that nothing holds the removable cap in place other than the interface between the cap and the surface of the grease tube, which means that a small amount of force can remove the cap and expose the contents of the grease tube to contamination.

Another shortcoming of current grease tubes is that they provide limited evidence of tampering. While a damaged or removed pull top may be an indication of tampering, the removable cap often presents no evidence of whether the grease tube has been opened previously. When tamper indicators are present, the current grease tubes are assembled with one step to install a tamper indicator and a separate step for printing the labeling information on the surface of the grease tube.

Another shortcoming of current grease tubes is that the tubular material may lack sufficient structural strength or integrity to endure rough handling. Impacts to the grease tube may result in a failure of the tube material and leakage of the grease.

There is a need for a lubricant tube with labeling print that is not effaced or damaged by exposure to water or grease. There is also a need for a method of packaging and repackaging grease in tubes that use a common container size for more efficient storage. There is a need to have the ability to repackage tubes for different customer requirements. There is a need to be able to easily print information on both fiber and plastic tubes. There is a need for a grease tube that provides tamper per evidence and reduced spillage risk. There is also need for reinforcement of the lubricant tube material to prevent ruptures due to impacts and rough handling.

### BRIEF SUMMARY OF THE DISCLOSURE

In aspects, the present disclosure is related to lubricant packaging, especially labeling and tamper evidence for grease tubes.

One embodiment according to the present disclosure includes a method for labeling a lubricant tube, the method comprising the steps of: priming labeling information on a plastic sleeve to form a printed side; and applying the plastic sleeve to a surface of a lubricant tube, wherein the printed side is direct contact with the surface, and wherein the plastic sleeve completely encloses a circumference of the lubricant tube when applied. The step of applying the plastic sleeve may include shrinking the plastic sleeve to conform to the surface of the lubricant tube. The lubricant tube may include a cylindrical tube having a having a first end and a second end; and a cap, and wherein the step of applying the plastic sleeve further comprises: securing the cap to the first end of the cylindrical tube with the plastic sleeve. The plastic sleeve may include a perforation, where the method includes orienting the cap and the plastic sleeve so that the perforation is closer to the first end than the second end. The perforation may be a t-perforation. The method may also include measuring a length and the circumference of the lubricant tube; selecting a width of the plastic sleeve to be greater than the circumference of the lubricant tube; and selecting a length of the plastic sleeve to be greater than the length of the lubricant tube. The plastic sleeve may be, at least in part, transparent. The lubricant tube may be a grease tube, and may be made of plastic or fiber.

Another embodiment according to the present disclosure includes a lubricant tube comprising: a cylindrical tube; and a plastic sleeve completely surrounding the cylindrical tube, the plastic sleeve comprising: a plastic layer with an inner surface and an outer surface; and printed information on the inner surface. The lubricant tube may include a cap disposed on a first side of the cylindrical tube, wherein the plastic sleeve secures the cap to the first side. The plastic sleeve may include a perforation around its circumference and longitudinally aligned with the cap. The perforation may be a t-perforation. The plastic layer may include PVC. The plastic layer may be transparent, at least in part. The lubricant tube may comprise at least one of fiber and plastic.

Examples of the more important features of the disclosure have been summarized rather broadly in order that the detailed description thereof that follows may be better understood and in order that the contributions they represent to the art may he appreciated. There are, of course, additional features of the disclosure that will be described hereinafter and which will form the subject of the claims appended hereto.

### BRIEF DESCRIPTION OF THE DRAWINGS

A better understanding of the present disclosure can be obtained with the following detailed descriptions of the various disclosed embodiments in the drawings, which are given by way of illustration only, and thus are not limiting the present disclosure, and wherein:

FIG. 1 is a diagram of a sleeved lubricant tube according to one embodiment of the present disclosure;

FIG. 2 is a flow chart of a method for labeling a lubricant tube according to one embodiment of the present disclosure.

FIG. 3A is a diagram of the pre-rolled sleeve with labeling information according to one embodiment of the present disclosure.

FIG. 3B is a 3-D view of the rolled sleeve with labeling information on the interior printed surface;

FIG. 3C is a 3-D view of the roiled sleeve surrounding a cylindrical tube according to one embodiment of the present disclosure; and

FIG. 3D is a 3-D view of the cylindrical tube with cap after the sleeve has been shrunk to fit according to one embodiment of the present disclosure; and

FIG. 4 is a flow chart of another method for labeling a lubricant tube using a pre perforated sleeve according to one embodiment of the present disclosure.

### DETAILED DESCRIPTION OF THE DISCLOSURE

In aspects, the present disclosure is related to lubricant packaging. Specifically, the present disclosure is related to especially labeling and tamper evidence for grease tubes. The present invention is susceptible to embodiments of different forms. There are shown in the drawings, and herein will be described in detail, specific embodiments with the understanding that the present invention is to be considered an exemplification of the principles and is not intended to limit the present invention to that illustrated and described herein.

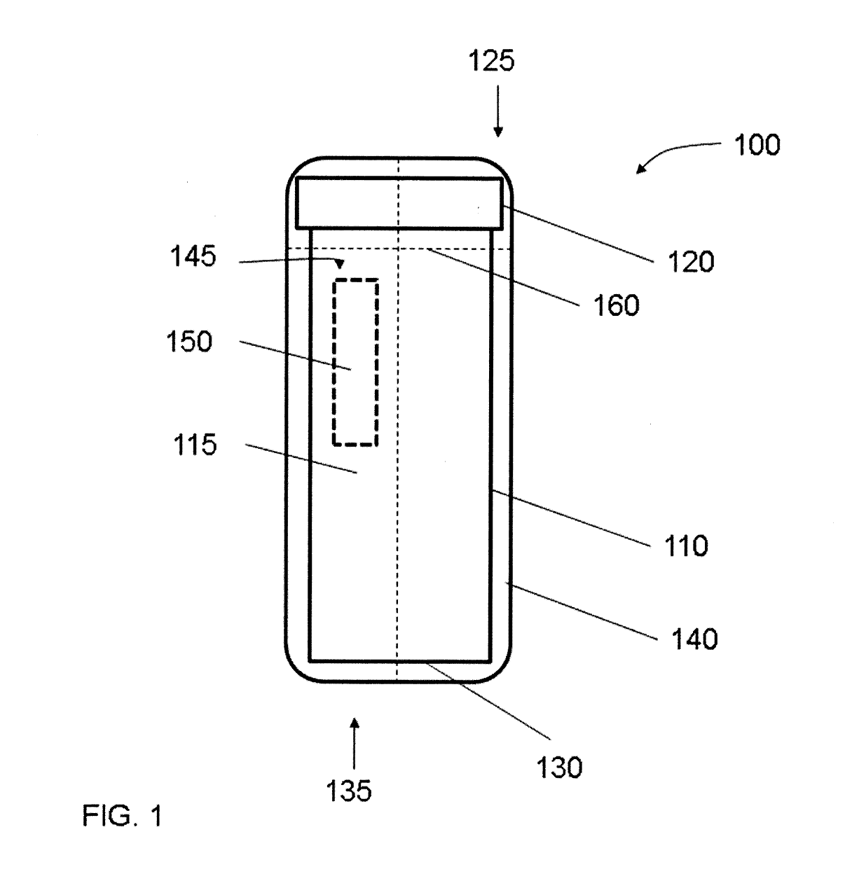

FIG. 1 shows a diagram of a shrink sleeved lubricant tube 100 that includes a cylindrical tube 110 with a cap 120 on a resealable first end 125 and a pull top 130 on a non-resealable second end 135. The cylindrical tube 110 and, optionally, the cap 120 are surrounded by a sleeve 140. The cylindrical tube 110 may be made of any material suitable for storing grease of a grease-based material, including, but not limited to, one of: fiber and plastic. The cap 120 may be made of the same or a different material as the cylindrical tube 110 so long as the cap material is selected not to degrade when in contact with the grease or grease-based material.

The sleeve 140 may be made of a plastic or other water proof material, including, but not limited to, polyvinyl chloride (PVC). In one embodiment, the sleeve 140 may comprise Kolckner PVC 62%. The sleeve 140 may include printed information 150 about the product stored in the cylindrical tube 110. The printed information 150 may be printed on the inside of the sleeve 140 such that a printed surface 145 of the sleeve is in direct contact with an outer surface 115 of the cylindrical tube 110. At least a portion of the sleeve 140, where the printed information 150 is present, is transparent so that the printed information 150 may be read while the sleeve 140 is applied to the cylindrical tube 110.

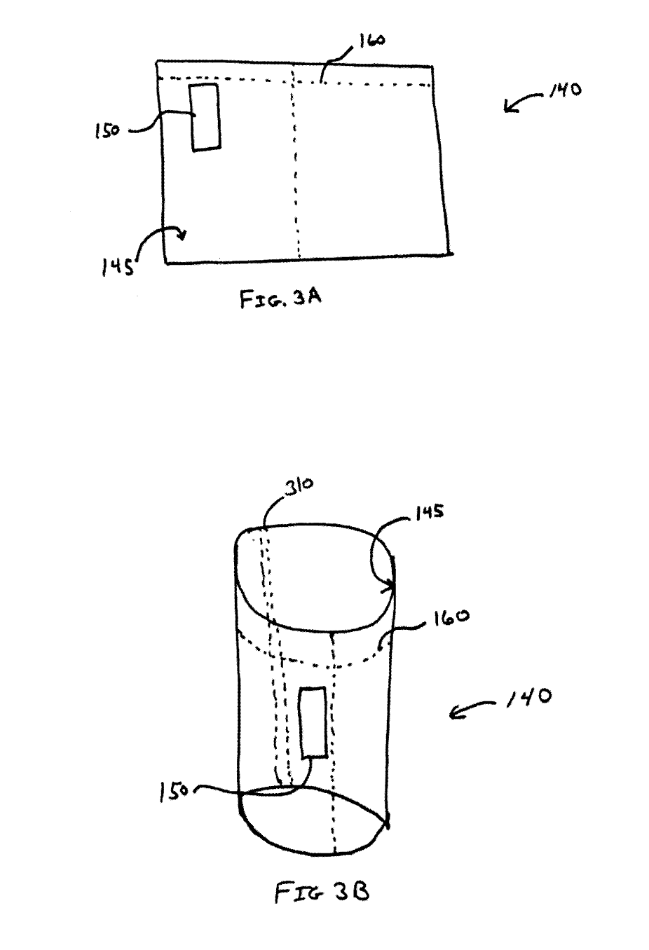

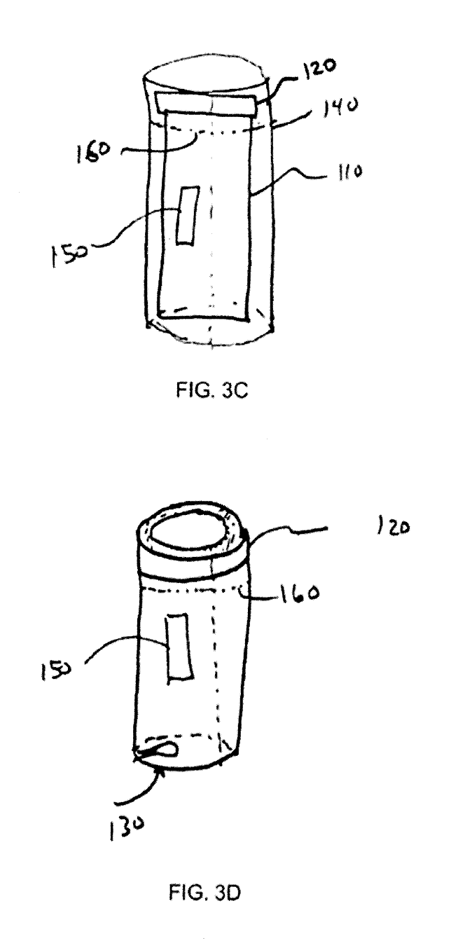

The sleeve 140 may be dimensioned to have a width at least as wide as the cylindrical tube 110 is long. The sleeve 140 may be sufficiently wide so that a portion of the sleeve may be folded to secure the cap 120 to the cylindrical tube 110. The length of the sleeve 140 may be as long as or slightly longer than the larger circumference of the cylindrical tube 110 and the cap 120. The excess length of the sleeve 140 may be used to create an overlap 310 (FIG. 3B) when the sleeve 140 is rolled for disposition around the cylindrical tube 110 and the cap 120.

When applied to the cylindrical tube 110, the sleeve 140 may be folded to enclose at least part of the cap 120 to form a tamper resistant/tamper evidence seal. The sleeve 140 may include a perforation 160 to allow the user to remove a portion of the sleeve 140 enclosing the cap 120 while leaving the rest of the sleeve 140 intact and protecting the cylindrical tube 110 from contact with water and grease. In some aspects, the perforation 160 may t-shaped. In one embodiment, the perforation 160 may be about 23 mm from the first end 125 of the sleeve 140. The sleeve 140 may also reinforce the structural integrity of the cylindrical tube 110 and prevent leaks and spillage.

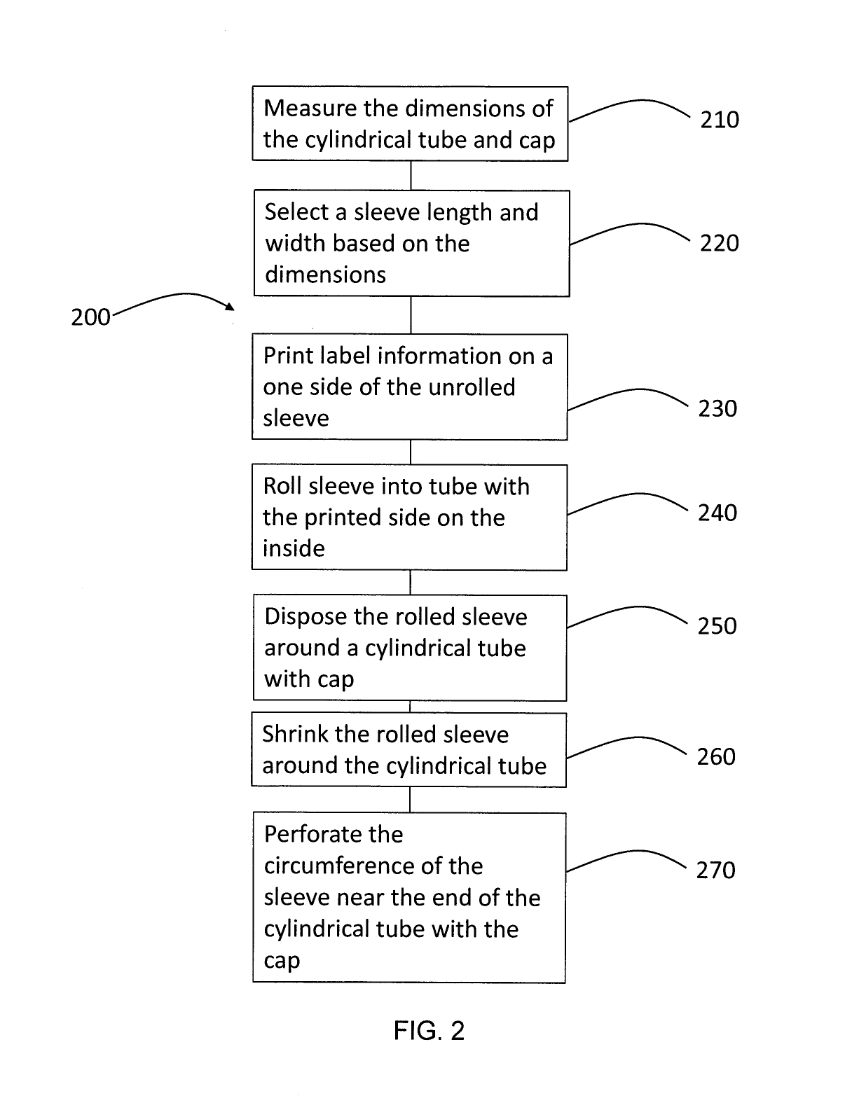

FIG. 2 shows a method 200 of labeling the lubricant tube 100. In step 210, the dimensions of the cylindrical tube 110 with the cap 120 are measured. In some embodiments, the additional width for the cap 120 is optional. In step 220, the plastic sleeve 140, in an unrolled state (FIG. 3A), may be selected such that the width of the plastic sleeve 140 greater than the length of the cylindrical tube 110 (with or without the cap 120 as desired) and selected such that the length of the plastic sheet 140 is greater than the circumference of the cylindrical tube 110 and/or the cap 120. In step 230, labeling information is printed onto one side 145 of the sleeve 140 while it is in an unrolled state. In step 240, the sleeve 140 is rolled into a tube with the printed side 145 on the inside of the tube. In its rolled state, the sleeve 140 has a slightly larger circumference than the cylindrical tube 110 and cap 120 to accommodate heat shrinkage in step 260. In some aspects, the rolled sleeve 140 (FIG. 3B) may have an overlap 310, where one end of the sleeve 140 may be secured to the other end of the sleeve 140 by an adhesive or other bonding means known to those of ordinary skill in the art to aid the sleeve 140 in retaining its rolled shape. In step 250, the sleeve 140 is disposed around the cylindrical tube 110 and the cap 120 (FIG. 3C). The sleeve 140 completely surrounds the circumference of the cylindrical tube 110 to account for stresses and potential distortions in shape that may occur during the shrinking process. In step 260, the sleeve 140 is shrunk around the cylindrical tube 110 and cap 120. The shrinking includes the application of heat to reduce the size of the sleeve 140 and cause it to conform to the shape of the cylindrical tube 110 and the cap 120 (FIG. 3D). A portion of the sleeve 140 exceeding the top of the cap 120 may be folded onto the cap 120 to secure the cap 120 to the first end 125 of the cylindrical tube 110. In step 270, the circumference of the sleeve 140 may be perforated to weaken but not separate a portion of the sleeve 140 that includes the cap 120 so that the portion is easier to separate from the remainder of the sleeve 140. In one embodiment, the perforation 160 may be placed about 23 mm from the first end 125 of the sleeve 140. In some embodiments, step 270 may take place while the sleeve 140 is still unrolled either before step 240.

FIGS. 3A-3D show the steps of the method of applying labeling information to the shrink sleeved lubricant tube 100 from FIG. 2. FIG. 3A shows the printed information 150 applied to the sleeve 140 on one side. Images and/or text in the printed information 150 are displayed so that they will be viewed with the correct orientation when the reader is viewing the printed information 150 through the sleeve 140. FIG. 3B shows the sleeve 140 formed into tube that is larger in circumference than the circumference of the cylindrical tube 110 and the cap 120. The sleeve 140 is longer than the cylindrical tube 110 so that there will be excess material that can he folded over the cap 120. The sleeve 140 is greater in width than the circumference of the cylindrical tube so that, when applied, the sleeve 140 will have an overlap 310. Heat or adhesive may be applied in the overlap 310 to keep the sleeve 140 in a tubular shape. The FIG. 3C shows the cylindrical tube 110 and the cap 120 inserted into the sleeve 140. The perforation. 160 is aligned with the first end 125 so that breaking the perforation 160 is required to remove the cap 120 from the cylindrical tube 110. In some embodiments, the perforation 160 may be a t-perforation that runs the circumference of or near the cap 120 and also runs along the length cylindrical tube 110. FIG. 3D shows the sleeve 140 shrinking around the cylindrical tube 110 and being folded over the cap 120. In some embodiments, the sleeve 140 may extend below the second end 135 so that the extended portion of the sleeve 140 may be folded over the pull up 130.

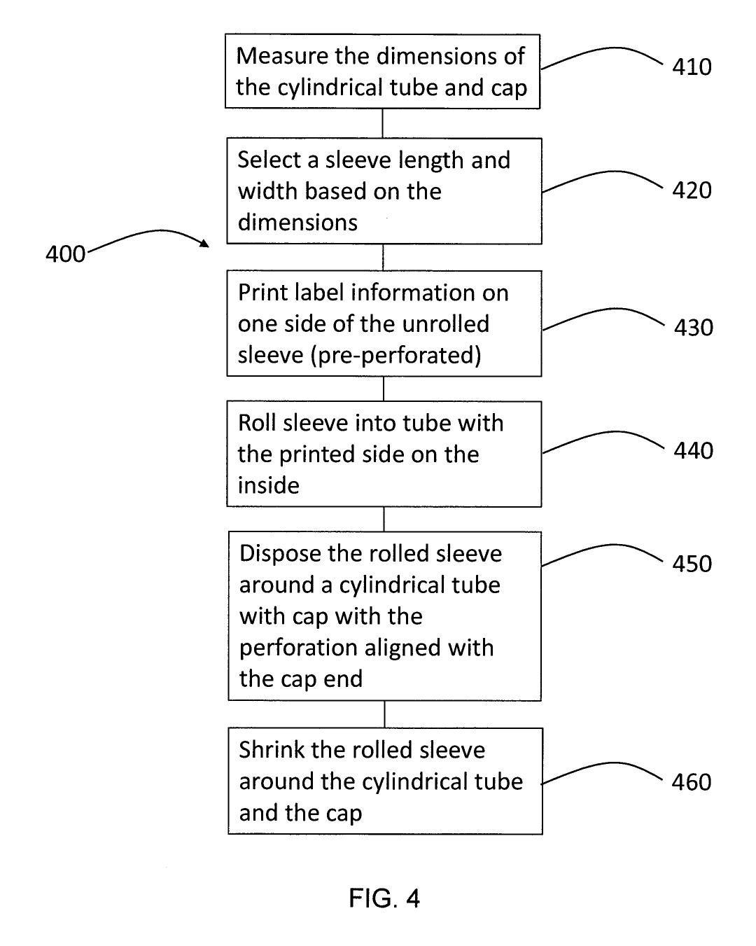

FIG. 4 shows another method 400 of labeling the lubricant tube 100. Similar to the method 200, the dimensions of the cylindrical tube 110, and optionally the cap 120, are estimated and an appropriately sized plastic sleeve 140 is selected. In step 410, the dimensions of the cylindrical tube 110 with the cap 120 are measured. In some embodiments, the additional width for the cap 120 is optional. In step 420, the plastic sleeve 140, in an unrolled state, may be selected such that the width of the plastic sleeve 140 greater than the length of the cylindrical tube 110 (with or without the cap 120 as desired) and selected such that the length of the plastic sheet 140 is greater than the circumference of the cylindrical tube 110 and/or the cap 120. In step 430, labeling information is printed onto a side 145 of the sleeve 140 while it is in an unrolled state. The sleeve 140 already has the perforation 160. In step 440, the sleeve 140 is rolled into a tube with the printed side 145 on the inside of the tube and the perforation 160 along a circumference of the rolled sleeve 140. In step 450, the sleeve 140 is disposed around the cylindrical tube 110 and the cap 120 with the perforation 160 aligned to be close to the first end 125 than the second end 135. In step 460, the sleeve 140 is shrunk around the cylindrical tube 110 and the cap 120. The shrinking includes the application of heat to reduce the size of the sleeve 140 and cause it to conform to the shape of the cylindrical tube 110 and the cap 120. A portion of the sleeve 140 exceeding the top of the cap 120 may be folded onto the cap 120 to secure the cap 120 to the first end 125 of the cylindrical tube 110.

In some aspects, it is contemplated that users may obtain lubricants, such as grease, in multiple containers of different sizes. The grease may be repackaged into uniform containers with new labels according to the methods 200 and 400. This way, storage of the lubricant tubes may be optimized through a universal size for storage.

While embodiments in the present disclosure have been described in some detail, according to the preferred embodiments illustrated above, it is not meant to be limiting to modifications such as would be obvious to those skilled in the art.

The foregoing disclosure and description of the disclosure are illustrative and explanatory thereof, and various changes in the details of the illustrated apparatus and system, and the construction and the method of operation may be made without departing from the spirit of the disclosure.

1. A method for labeling a lubricant tube, the method comprising the steps of:
printing labeling information on a plastic sleeve to form a printed side; and
applying the plastic sleeve to a surface of a lubricant tube, wherein the printed side is direct contact with the surface, and wherein the plastic sleeve completely encloses a circumference of the lubricant tube when applied.

2. The method of claim 1, wherein the step of applying the plastic sleeve comprises: shrinking the plastic sleeve to conform to the surface of the lubricant tube.

3. The method of claim 1, wherein the lubricant tube comprises a cylindrical tube having a having a first end and a second end; and a cap, and wherein the step of applying the plastic sleeve further comprises: securing the cap to the first end of the cylindrical tube with the plastic sleeve.

4. The method of claim 3, wherein the plastic sleeve includes a perforation, the method comprising: orienting the cap and the plastic sleeve so that the perforation is closer to the first end than the second end.

5. The method of claim 4, wherein the perforation is a t-perforation.

6. The method of claim 1, further comprising:
measuring a length and the circumference of the lubricant tube;
selecting a width of the plastic sleeve to be greater than the circumference of the lubricant tube; and
selecting a length of the plastic sleeve to be greater than the length of the lubricant tube.

7. The method of claim 1, wherein at least part of the plastic sleeve is transparent.

8. The method of claim 1, wherein the lubricant tube is a grease tube.

9. The method of claim 1, wherein the lubricant tube is one of: plastic and fiber.

10.-16. (canceled)
